(19) United States
(12) Patent Application Publication
(10) Pub. No.: US 2026/0054780 A1
(43) Pub. Date: Feb. 26, 2026

(54) CAR SPOILER

(71) Applicants: SENG-KIAT GOH, Melaka (MY); JASON CHOU, BALDWIN PARK, CA (US)

(72) Inventors: SENG-KIAT GOH, Melaka (MY); JASON CHOU, BALDWIN PARK, CA (US)

(21) Appl. No.: 18/809,371

(22) Filed: Aug. 20, 2024

(51) Int. Cl. B62D 35/00; B62D 37/02

(52) U.S. Cl. CPC B62D 35/007; B62D 37/02

(57) ABSTRACT

A car spoiler may include a spoiler, and the spoiler has two arms, a main body, and two lateral portions. The two arms secured on a vehicle are connected to the main body, and each of two lateral ends of the main body is connected to one lateral portion. A rear side of the main body has at least a spoiler piece, and the spoiler piece is assembled with the main body through any number of connecting member, so that the different shapes, sizes, angles and curvatures of spoiler piece is detached, replaced, and reassembled with the main body to improve the stability of the vehicle.

### FIELD OF THE INVENTION

The present invention relates to a car spoiler and more particularly to a flexibly adjusted and replaced car spoiler.

### BACKGROUND OF THE INVENTION

In order to reduce air resistance, the design of a car body needs to consider fluid dynamics, so that the rear end of the car may be equipped with a car spoiler which can guide airflow and balance the car so as to make the car more stable on the ground. Especially for racing cars, the car spoiler is an indispensable component that enhances both speed and stability.

However, the conventional car spoiler has following disadvantages: as tires need to be replaced to suit different environmental conditions, the car spoiler also needs to adjust its size, shape, angle and curvature to match different airflow conditions, and for scenario like car racing where every second counts, it is essential to minimize the works and time required for adjusting or replacing the car spoiler. Therefore, there remains a need for a new and improved design for a car spoiler to overcome the problems presented above.

### SUMMARY OF THE INVENTION

The present invention provides a car spoiler comprising a spoiler, and the spoiler has two arms, a main body, and two lateral portions. The two arms secured on a vehicle are connected to the main body, and each of two lateral ends of the main body is connected to one lateral portion. A rear side of the main body has at least a spoiler piece, and the spoiler piece is assembled with the main body through any number of connecting member, so that the different shapes, sizes, angles and curvatures of spoiler piece is detached, replaced, and reassembled with the main body to improve the stability of the vehicle.

Comparing with conventional car spoiler, the present invention is advantageous because: (i) the spoiler piece is easily detached, replaced, and reassembled with the main body, so that the user can install the spoiler piece of different shapes, sizes, angles, and curvatures onto the main body according to their needs, so as to improve the flexibility in use and to quickly adjust to air resistance; (ii) the spoiler is adapted to apply to time-sensitive situation such as racing competitions that the different of spoiler pieces are rapidly replaced according to current environmental factors such as wind direction and speed, so as to enhance the stability of vehicle immediately.

### BRIEF DESCRIPTION OF THE DRAWINGS

FIG. 1 is a three-dimensional assembly view of a car spoiler of the present invention.

FIG. 2 is an exploded view of the car spoiler of the present invention.

FIG. 3 is a top view of the car spoiler of the present invention.

FIG. 4 is a lateral sectional view of the car spoiler of the present invention.

FIG. 5 is a schematic view of a spoiler piece of the car spoiler at another angle in the present invention.

FIG. 6 is a schematic view of the spoiler piece of the car spoiler at a third angle in the present invention.

FIG. 7 is an exploded view of a second embodiment of the car spoiler in the present invention.

FIG. 8 is a top view of the second embodiment of the car spoiler in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention. Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

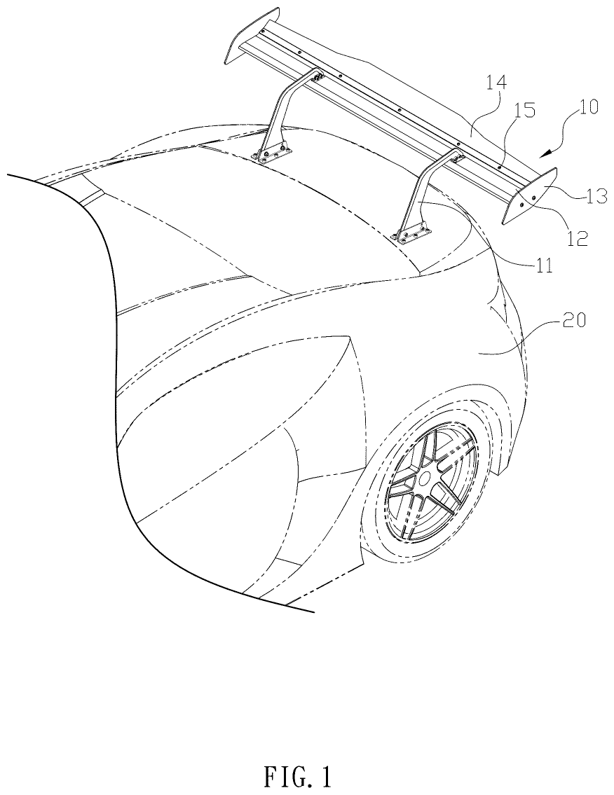

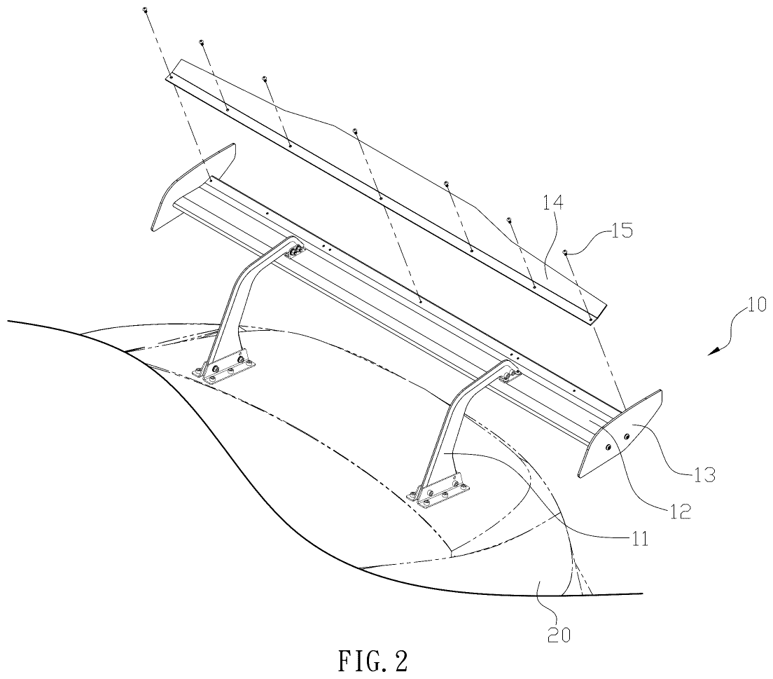

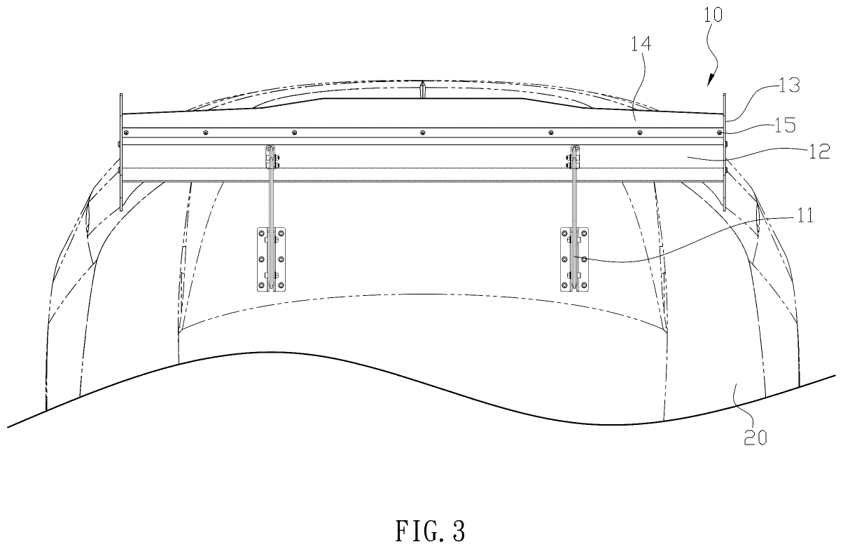

Referring to FIGS. 1 to 4, the present invention provides a car spoiler comprising a spoiler (10), and the spoiler (10) has two arms (11), a main body (12), and two lateral portions (13). The two arms (11) secured on a vehicle (20) are connected to the main body (12), and each of two lateral ends of the main body (12) is connected to one lateral portion (13). Moreover, A rear side of the main body (12) has at least a spoiler piece (14), and the spoiler piece (14) is assembled with the main body (12) through any number of connecting member (15), so that the different shapes, sizes, angles and curvatures of spoiler piece (14) is detached, replaced, and reassembled with the main body (12) to improve the stability of the vehicle (20).

The spoiler piece (14) is easily detached, replaced, and reassembled with the main body (12), so that the user can install the spoiler piece (14) of different shapes, sizes, angles, and curvatures onto the main body (12) according to their needs, so as to improve the flexibility in use and to quickly adjust to air resistance.

In actual application, the spoiler piece (14) is easily detached, replaced, reassembled with the main body (12), and with the rapidly dissembled connecting members (15), the spoiler (10) is adapted to apply to time-sensitive situation such as racing competitions that the different of spoiler pieces (14) are rapidly replaced according to current environmental factors such as wind direction and speed, so as to enhance the stability of vehicle (20) immediately.

In one embodiment, the vehicle (20) is a racing car.

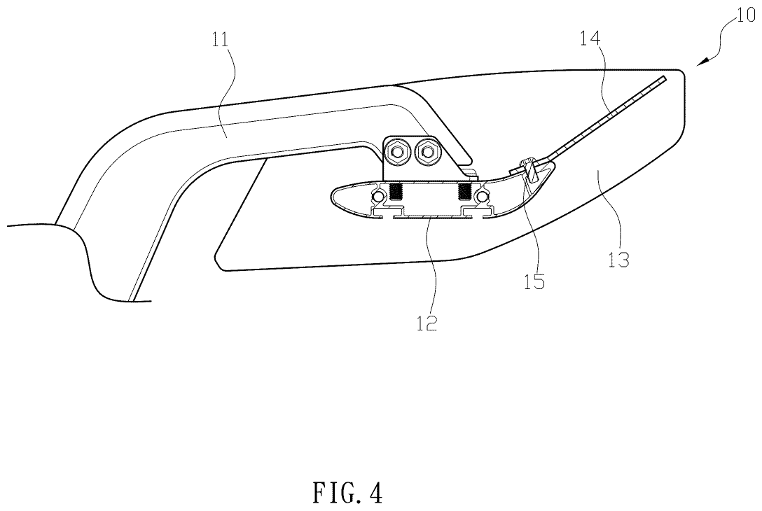

In another embodiment, referring to FIG. 4, the connecting member (15) is a threaded fastener such as a screw.

In still another embodiment, the connecting member (15) is a riveted piece such as a rivet.

In a further embodiment, the rear side of the main body (12) is tilted so that the spoiler piece (14) has a basic tilt angle after installation.

In still a further embodiment, the rear side of the main body (12) is tilted upward between 15 degrees and 55 degrees above the horizontal plane, which is a more commonly used preset tilt angle range.

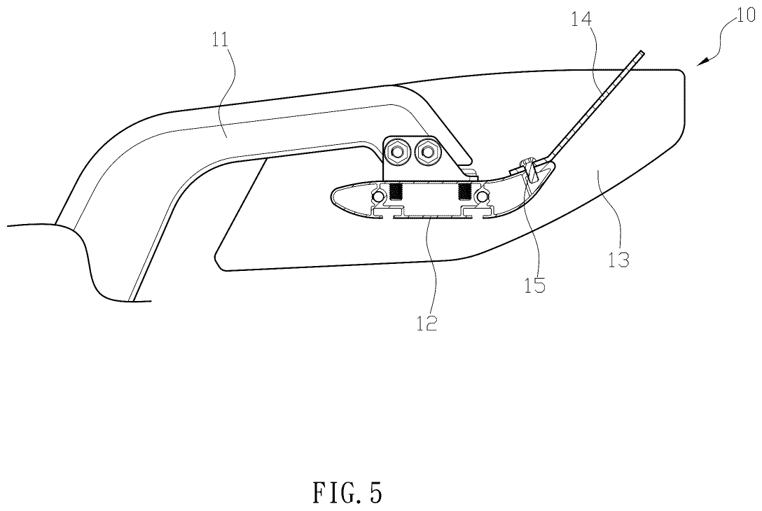

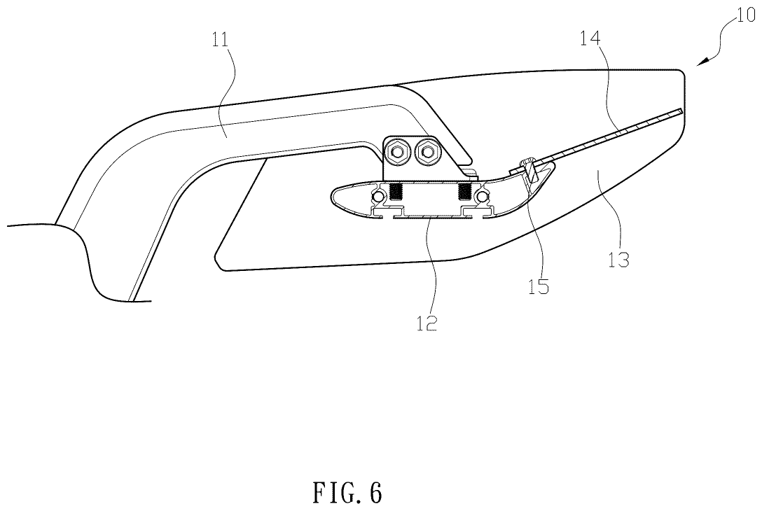

Referring to FIG. 5, the spoiler piece (14) is formed with an angle to create a larger angle above the horizontal plane; and referring to FIG. 6, the spoiler piece (14) is formed in a plane shape.

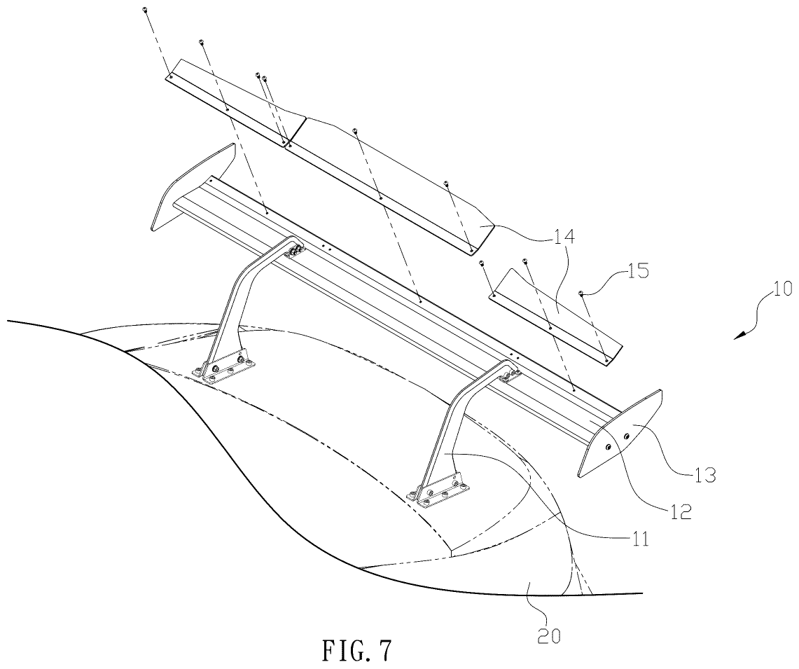

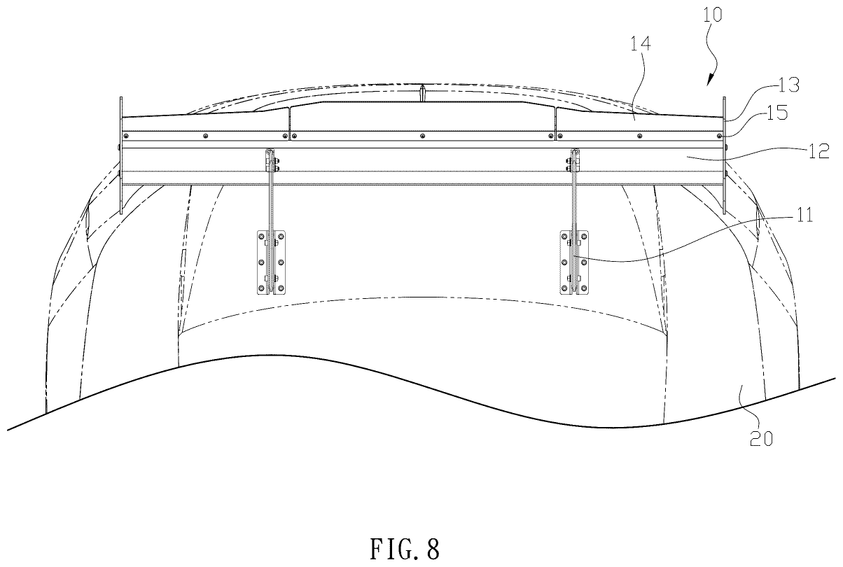

Referring to FIGS. 1 to 3, the main body (12) is connected to one spoiler piece (14), and referring to FIGS. 7 and 8, in another embodiment, the main body (12) is connected to a plurality of spoiler pieces (14). The number of the spoiler pieces (14) is adapted to affect the workload during assembly and the flexibility of adjustment, and when the main body (12) is connected to multiple spoiler pieces (14), the requirements are met by matching the spoiler pieces (14) with different shapes. In a preferable embodiment, the number of the spoiler pieces (14) is three to achieve the balance between flexibility of use and assembly workload.

In an advantageous embodiment, the arms (11), the main body (12), and the lateral portions (13) are assembled and secured together by screws, and the arms (11) and the vehicle (20) are assembled and secured by screws.

In another advantageous embodiment, the arms (11), the main body (12), and the lateral portions (13) are assembled and secured together by rivets, and the arms (11) and the vehicle (20) are assembled and secured by rivets.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A car spoiler comprising a spoiler;
wherein the spoiler has two arms, a main body, and two lateral portions; the two arms secured on a vehicle are connected to the main body, and each of two lateral ends of the main body is connected to one lateral portion; a rear side of the main body has at least a spoiler piece, and the spoiler piece is assembled with the main body through any number of connecting member, so that the different shapes, sizes, angles and curvatures of spoiler piece is detached, replaced, and reassembled with the main body to improve the stability of the vehicle.

2. The car spoiler of claim 1, wherein the connecting member is a threaded fastener.

3. The car spoiler of claim 1, wherein the connecting member is a riveted piece.

4. The car spoiler of claim 1, wherein the rear side of the main body is tilted.

5. The car spoiler of claim 4, wherein the rear side of the main body is tilted upward between 15 degrees and 55 degrees above the horizontal plane.

6. The car spoiler of claim 1, wherein the main body is connected to one spoiler piece.

7. The car spoiler of claim 1, wherein the main body is connected to a plurality of spoiler pieces.

8. The car spoiler of claim 7, wherein the main body is connected to three spoiler pieces.

9. The car spoiler of claim 1, wherein the arms, the main body, and the lateral portions are assembled and secured together by threaded fasteners, and the arms and the vehicle are assembled and secured by threaded fasteners.

10. The car spoiler of claim 1, wherein the arms, the main body, and the lateral portions are assembled and secured together by riveted pieces, and the arms and the vehicle are assembled and secured by riveted pieces.
